(19) United States
(12) Patent Application Publication
(10) Pub. No.: US 2009/0307841 A1
(43) Pub. Date: Dec. 17, 2009

(54) SYSTEM FOR TURNING A PATIENT

(76) Inventors: Allan Richard James, Herefordshire (GB); Joyce Irene James, Herefordshire (GB)

Correspondence Address: KING & SCHICKLI, PLLC, 247 NORTH BROADWAY, LEXINGTON, KY, 40507, US

(21) Appl. No.: 11/721,187

(22) PCT Filed: Dec. 5, 2005
(86) PCT No.: PCT/GB05/04691

§ 371 Date: Aug. 17, 2009

(30) Foreign Application Priority Data
Dec. 8, 2004 (GB) 0426892.6
Oct. 6, 2005 (GB) 0520286.6

(51) Int. Cl. A61G 7/10; A61G 7/00

(52) U.S. Cl. 5/88.1; 5/83.1; 5/86.1

(57) ABSTRACT

Apparatus for turning a patient including a mobile support (11) having an overhanging portion defining a pair of spaced locations, a roller (32, 34) mounted at each location such that the rollers (32, 34) extend generally parallel to each other, the rollers (32, 34) together being for supporting a dependent sling (48) therebetween, and means for rotating the rollers (32, 34) whereby the sling (48) can be moved laterally relative to the patient to turn the patient.

This invention relates to a system for turning a patient lying on a sheet in a bed, with particular, by no means exclusive, reference to bed-ridden patients in a hospital or like medical institution, or a nursing home.

Bed-ridden patients require frequent turning for a variety of reasons, such as to change bed sheets, to clean the patient, to change the postural alignment of the patient, to change dressings, to carry out surgical procedures such as insertion of a chest drain or epidural, and to perform therapy on the patients such as enabling fluid to be removed from the lungs. In an ITU (intensive therapy unit) department patients are usually rolled at least twice in a 7½ hour period, although it is not at all uncommon for four to five such procedures to be performed within this period of time per patient. A minimum of three nurses are required to carry out a procedure in which a patient on a bed is rolled safely. With a difficult, confused or agitated patient an extra nurse would be beneficial. However, in hospitals it is frequently the case that modern staffing arrangements do not enable even the minimum requirements to be met. In reality, it is commonly the case that only two nurses, or even a single nurse, is available to carry out the rolling procedure. The result is that the procedure is either not carried out at all, or the nurses that do carry out the procedure risk serious back injury. There is anecdotal evidence to suggest that back injuries amongst nurses associated with patient rolling procedures are becoming a serious problem in modern healthcare.

Mechanical systems for rolling bed-ridden patients have long been known. However, known systems are generally either formed as an integral part of the bed or are intended to be coupled with or placed upon a bed.

The present invention is based on the realization that it would be highly advantageous to provide an apparatus which is not dedicated to a single bed, but, rather, may be moved from one bed to another in order to roll a number of patients without risking injury to nursing staff. The present inventors have appreciated that such uses have an attendant risk of cross contamination, and at least some embodiments of the present invention seek to overcome this problem.

For the avoidance of doubt, the term “sling” as used herein includes reference to any sheet-like material forming a substrate on which a patient may lie, including a material layer, net or web.

According to a first aspect of the invention there is provided apparatus for turning a patient including a mobile support having an overhanging portion defining a pair of spaced locations, a roller mounted at each location such that the rollers extend generally parallel to each other, the rollers together being for supporting a dependent sling therebetween, and means for rotating the rollers whereby the sling can be moved laterally relative to the patient to turn the patient.

Preferably, the means for rotating the rollers can additionally rotate the rollers in use to shorten the sling so as to lift a patient lying therebetween. In this way, the apparatus can also function as a hoisting device. The rollers would be rotatable to lengthen the sling as well so as to lower a patent lying therebetween.

In a preferred embodiment, the mobile support comprises a single structure.

In an alternative embodiment, the mobile support comprises two or more linked structures. With this embodiment, the two structures are separately transportable between beds. Advantageously, the structures are disposed on either side of a bed. In order to facilitate the correct mutual alignment of the two devices, the devices may interlock.

The rollers may have releasable coupling means for releasably coupling the rotatable shafts to the sling. In this way, cross contamination between beds can be reduced. In such embodiments, the releasable coupling means on at least one of the rollers may comprise a length of material in connection with the roller. In alternative embodiments, the sling has releasable coupling means for coupling to the rollers. Other releasable coupling means might be used, such as hooks, clips, clamps, slots, or material attachment means such as Velcro®.

It is preferred that at least one roller is permanently mounted on the overhanging portion. “Permanently” means, in this context, that the roller can only be detached using specialist tools. Alternatively, at least one roller may be detachably mounted on the overhanging portion. In this way, once a patient has been turned, a roller may be removed in order to permit access to the patient. The apparatus may comprise a plurality of pairs of detachably mountable rollers. In this way, a pair of rollers may be dedicated to each bed with which the apparatus is intended to be used, with a dedicated pair of rollers being mounted on the overhanging portion when the apparatus is transported to a bed, and detached when the apparatus is moved to another bed. An advantage of this approach is that cross contamination is reduced.

Preferably the mobile support includes one or more uprights, preferably at least two uprights, most preferably two uprights.

Preferably, the overhanging portion includes at least two cross members. The overhanging portion may further include a linking arrangement linking the rollers to the cross members. The cross members may extend substantially transversely with respect to the rollers up to a transverse limit, and at least a portion of the linking arrangement may extend substantially transversely with respect to the rollers beyond the transverse limit of the cross members. In this way, the cross members can be configured so that, in use, the cross members extend across only a portion of the patient's bed, providing improved access to the bed when the apparatus is in place.

The apparatus may further include means for lowering and raising a roller between a raised, in-use position and a lowered position. When a roller is in the lowered position, access is provided to a patient lying on the bed. In this way, a sling positioned on the bed can remain attached to the apparatus during an entire nursing procedure, with a roller being raised and lowered as required in order to provide access to the patient. The means for lowering and raising a roller may include a lever mechanism. Preferably, the apparatus is of the above described type in which the overhanging portion further includes a linking arrangement linking the rollers to the cross members, in which instance the means for lowering and raising a roller may include the linking arrangement. Preferably, a control arrangement ensures that the rollers can only be rotated when the rollers are properly positioned in the raised, in-use position. Sensors, preferably electronic sensors, may be provided to determine when the rollers are in the raised, in-use position.

The means for lowering and raising a roller may be operated manually, or alternatively, may be a powered arrangement.

The apparatus may further comprise adjustment means for adjusting the longitudinal position of the rollers with respect to the overhanging portion. This facility is advantageous, since it allows an operative to align the rollers with the sling should, for example, the wheels of the bed be in an adverse position preventing the apparatus to be properly aligned with the bed or if the approach to the bed is obstructed. Additionally, a patient lying on the sling may be moved longitudinally up or down the bed. In the prior art, this task is either done manually, with the risk of injury to the operative performing the task, and/or with the use of slide sheets, which also have the potential to cause injury to the operative. The adjustment means may include a pivotably mounted connector connected to the rollers. Preferably, the apparatus is of the above described type in which the overhanging portion further includes a linking arrangement linking the rollers to the cross members, in which instance the adjustment means may include the linking arrangement. The linking arrangement may include a plurality of pivotable arms connecting the rollers to the cross members. The pivotable arms may pivot about a cross member or an intermediate portion disposed between a pivotable arm and its corresponding cross member.

In alternative arrangements, the adjustment means includes sliding means enabling the rollers to slide longitudinally with respect to the overhanging portion. The sliding means may include one or more tracks disposed on the overhanging portion on which a roller can slide.

Preferably the adjustment means further includes drive means for causing longitudinal movement of the rollers. The drive means may include an actuator. Alternatively, the adjustment means may be operated manually.

Advantageously, embodiments which include adjustment means for adjusting the longitudinal position of the rollers with respect to the overhanging portion are ones in which the means for rotating the rollers can additionally rotate the rollers to shorten the sling so as to lift the patient lying therebetween. In these advantageous embodiments, it is possible to hoist a patient and to position the patient longitudinally with respect to the bed. With prior art arrangements, it is difficult or impossible to position the patient longitudinally with respect to the bed.

The rollers are intended to be held above a bed around which they are disposed. Preferably, the rollers are held substantially above the bed, e.g., at least 30 cms, preferably at least 50 cms. Shaft height adjustment means may be provided to permit adjustment of the height of the rollers with respect to the apparatus (and to the bed).

The apparatus may further include a plurality of wheels enabling the apparatus to be mobile. The support may include a plurality of legs, the wheels being mounted on said legs. One or more legs may extend inwardly of the apparatus, substantially perpendicular to the rollers. This configuration provides structural stability. Additionally, or alternatively, one or more legs may extend outwardly of the apparatus, substantially parallel with the rollers.

It is preferred that one or more legs extend inwardly of the apparatus, substantially parallel with the rollers. This configuration provides enhanced structural stability.

Instead of legs, the support may include a chassis.

Preferably, four wheels are provided.

In preferred embodiments, the means for rotating the rollers includes roller drive means for rotating the rollers and control means for controlling the operation of the drive means. Typically, the drive means includes one or more motors appropriate for driving the rollers. The drive means may include a cam in operative connection with a roller. Other arrangements, such as a direct drive transmission, are within the scope of the invention. However, an advantage of using a cam is that a roller may be readily coupled thereto and detached therefrom.

The drive means may include a first drive shaft driven by a motor and second drive shaft, the first drive shaft being an operative connection with the second drive shaft through a linkage such an endless belt or chain.

The apparatus may further include a sling which is releasable coupled to the rollers. Typically, a plurality of slings are provided, and a different sling is used in conjunction with each bed that the apparatus is intended to be used with. In use, a sling on a bed is coupled to the rotatable shafts, and a patient on the bed is turned. After the appropriate procedure is completed, the sling is decoupled from the rollers, the apparatus is transported to another bed having disposed thereon another sling, and the procedure is repeated. The sling does not have to extend along the full length of the bed, and in preferred embodiments the dimensions of the sheet are such that in use the sling extends from around the shoulders to slightly below the hips of an average patient.

The use of adjustment means for adjusting the longitudinal position of the rollers with respect to the overhanging portion can be advantageously applied to other patient turning devices and to dedicated hoists which do not have patient turning capability. Thus, according to a second aspect of the invention there is provided apparatus for turning a patient including a support defining a pair of spaced locations, a roller mounted at each location such that the rollers extend generally parallel to each other, the rollers together being for supporting a dependent sling therebetween, means for rotating the rollers whereby the sling can be moved laterally relative to the patient to turn the patient, and adjustment means for adjusting the longitudinal position of the rollers with respect to the support.

The second aspect of the invention may utilise any of the elements described above in respect of the first aspect of the invention. In particular, the adjustment means may be as defined in respect of the first aspect of the invention. Preferably, the support is a mobile support.

According to a third aspect of the invention there is provided apparatus for lifting and lowering a patient including a support carrying sling supporting means for supporting a dependent sling and operable to lift and lower a patient lying in the sling, and adjustment means for adjusting the longitudinal position of the sling supporting means with respect to the support.

The sling support means sling may include a pair of rollers. Alternatively, the sling support means may include a hoist operable to lift and lower the patient. Actuators, motors, gears and other motion producing elements may be utilised to lift and lower the patient.

The third aspect of the invention may utilise any of the elements described above in respect of the first aspect of the invention. In particular, the adjustment means may be as defined in respect of the first aspect of the invention.

In a preferred embodiment the overhanging portion defines a pair of spaced locations, the sling supporting means includes a roller mounted at each location so that the rollers extend generally parallel to each other, the rollers together being for supporting the dependent sling therebetween, and means for rotating the rollers whereby the sling can be shortened so as to lift a patient lying therebetween and lengthened so as to lower a patient lying therebetween, and the adjustment means adjusts the longitudinal position of the rollers with respect to the overhanging portion.

Preferably, the support is a mobile support.

Embodiments of the systems in accordance with the invention will now be described, by way of example only, with reference to the accompanying drawings, in which:—

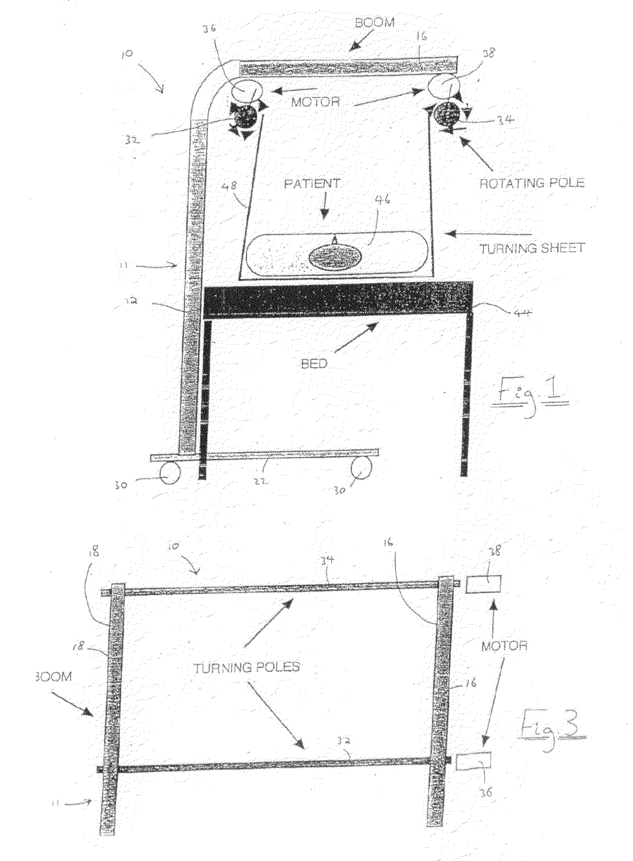

FIG. 1 is an end view of a first embodiment of a device of the invention positioned with respect to a bed;

FIG. 2 is a perspective view of the device of FIG. 1;

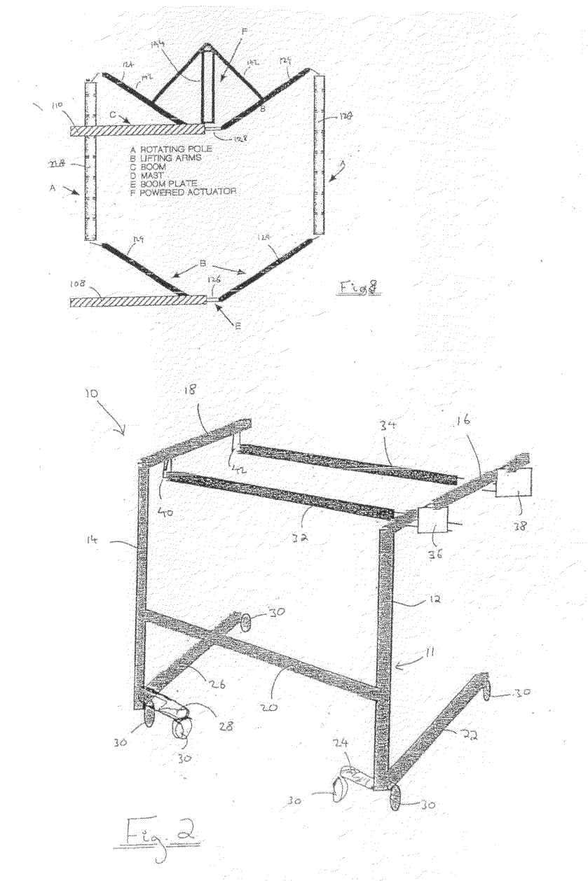

FIG. 3 is a plan view of the device of FIG. 1, with the strut and the legs being omitted for means of presentational clarity;

FIG. 4 is an enlarged end view of a drive arrangement;

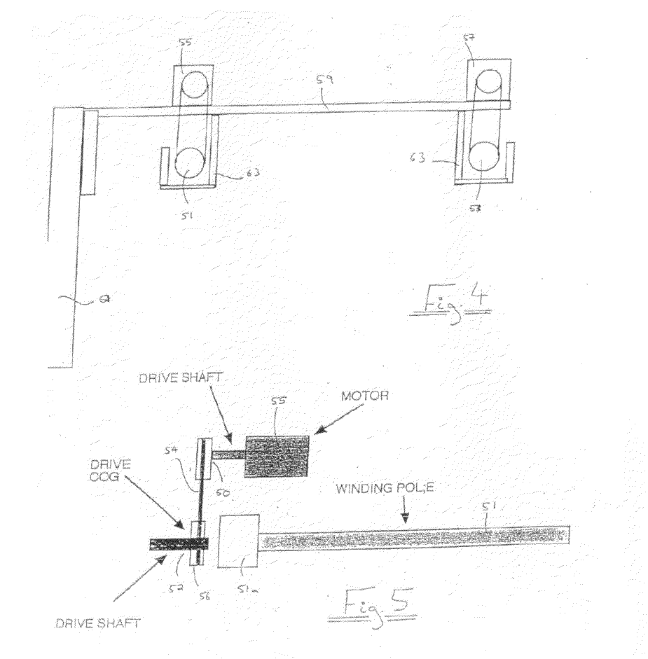

FIG. 5 is a side view of the drive arrangement of FIG. 4;

FIG. 6 shows (a) a rotatable shaft (b) the head portion of the rotatable shaft and (c) the foot portion of the rotatable shaft;

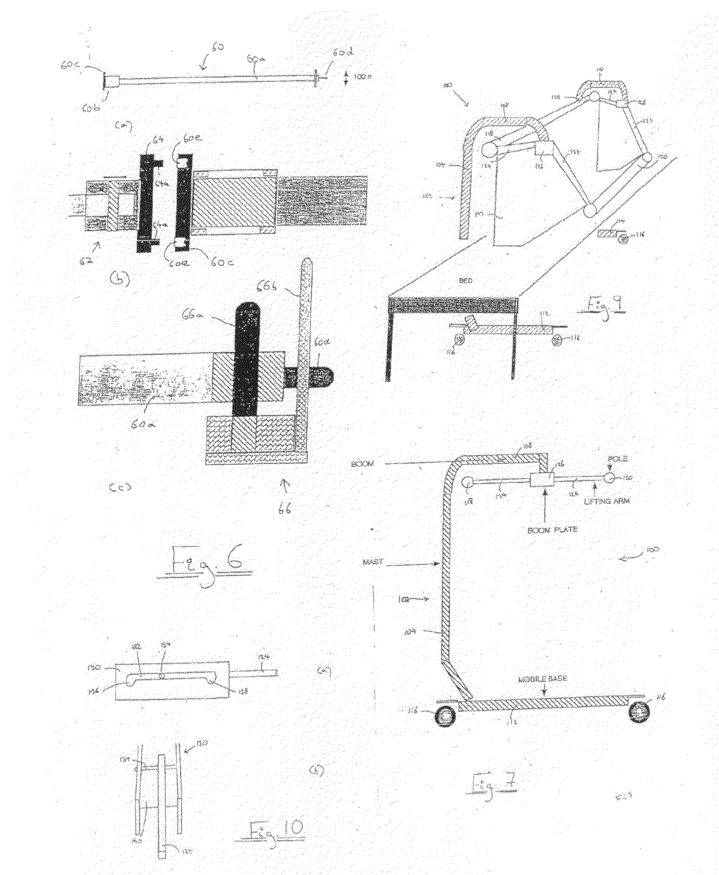

FIG. 7 is an end view of a second embodiment of a device of the invention;

FIG. 8 is a plan view of the second embodiment;

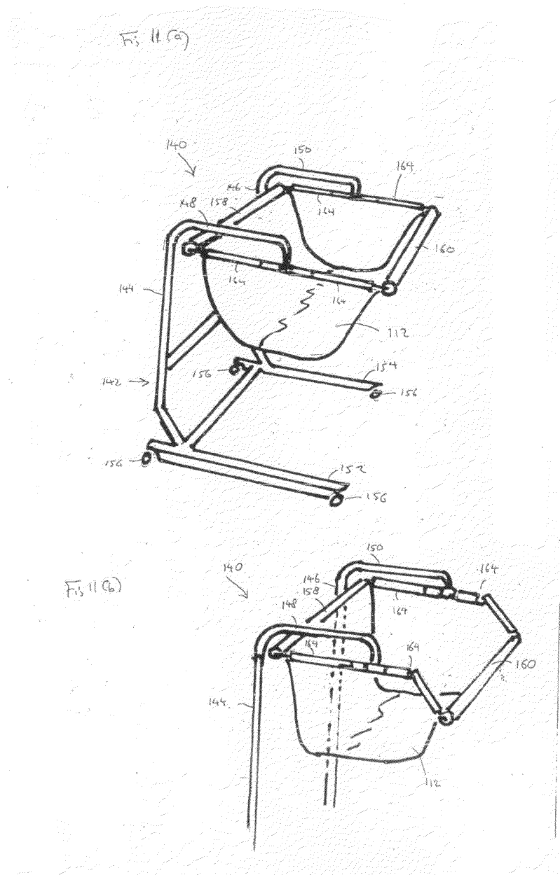

FIG. 9 is an end perspective view of the second embodiment positioned next to a bed;

FIG. 10 shows (a) an end view, and (b) a side view of an arrangement for lifting and lowering a roller;

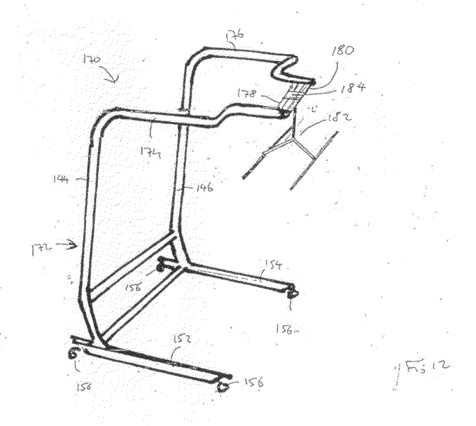

FIG. 11 shows end perspective views of a third embodiment of a device of the invention (a) with roller supporting arms up and (b) with roller supporting arms down; and

FIG. 12 is an end perspective view of a patient hoisting device.

FIGS. 1 to 3 show various views of a device of the invention, shown generally at 10. The device 10 includes a mobile support, shown generally at 11, which comprises a pair of masts 12, 14, each mast having a substantially horizontal boom 16, 18 extending therefrom, the booms extending in a common direction. A horizontal strut 20 connects the masts 12, 14 thereby providing structural stability to the device 10. The support 11 further comprises a plurality of horizontally extending legs 22, 24, 26, 28 having a plurality of ground engaging wheels 30 mounted thereon. More specifically, the mast 12 has an inwardly extending horizontal leg 22 which extends in a direction parallel to the booms 16, 18 and a short inwardly extending leg 24 which extends horizontally in a direction substantially perpendicular to the booms 16, 18. Ground engaging wheels 30 are mounted at either end of leg 22 and at the distal end of leg 24. Similarly, mast 14 has an inwardly extending leg 26 which extends horizontally in a direction substantially parallel to the booms 16, 18 and a short inwardly extending leg 28 which extends in a direction which is perpendicular to the booms 16, 18. Ground engaging wheels 30 are mounted at either end of the leg 26 and at the distal end of leg 28. This arrangement enables the device to be easily transported from bed to bed by a single operative, and easily positioned with respect to a bed. Other forms of suitable ground engaging transportation means would readily suggest themselves to the skilled reader. The device 10 further comprises a pair of rollers 32, 34 and a pair of motors 36, 38. Each motor 36, 38 is in operative connection with a roller 32, 34 in a manner which is described in greater detail below. The rollers 32, 34 are substantially parallel and are longitudinally spaced apart. Conveniently, the rollers 32, 34 are perpendicular to the booms 16, 18 and the masts 12, 14, although the skilled reader will appreciate that it is not essential that the device is so configured. The ends of the rollers 32, 34 which are opposite the motors 36, 38 are housed in cups 40, 42.

FIG. 1 shows the device 10 in use. The device 10 is transported to and placed against a bed 44 having a patient 46 lying thereon. In addition to conventional bedding (not shown) including pillows, blankets, conventional sheets and like, the bedding also comprises a sheet 48 which is connected to the rollers 32, 34. The sheet 48 can be formed from any suitable material, and may be a web or a net. It is not necessary that the sheet extends across the whole of the bed. In fact, the sheet 48 may be of approximate dimensions 120 cm×250 cm, with the shorter sides of the sheet being positioned parallel to the longitudinal axis of the bed so that the shoulders of the patient 46 lie around the top end of the sheet 48 with the bottom end of the sheet 48 being positioned in the vicinity of the patient's knees. It is preferred that the rolling procedure begins by lifting the patient 46 slightly from the bed 44. It will be appreciated that with the sheet 48 connected to the rollers 32, 34 in the manner shown in FIG. 1, lifting of the patient 46 from the bed 44 is accomplished by rotating the roller 32 anticlockwise and rotating the roller 34 clockwise. Once the patient 46 is clear of the bed 44, the rollers 32, 34 are rotated in a manner which causes the patient's body to rotate. Once the patient 46 has been rotated to a desired extent, the rollers 32, 34 are rotated so as to lower the patient 46 back onto the bed 44 in a stable position. One or more of the rollers 32, 34 are detachable from the device 10. In this instance, access to the patient 46 for washing and/or other medical procedures is possible by removing a rotatable shaft. In practice, it is desirable that the roller 34 at the distal ends of the booms 16, 18 is removed. Alternatively, the sheet 48 may be detached from one or more of the rollers 32, 34 to allow access to the patient 46. When the washing or other procedure has been completed, the device 10 is reassembled into an operative state, the patient is lifted, rotated to a desired position and then lowered. The sheet 48 is detached from the rollers 32, 34 allowing the device 10 to be removed from its operative position with respect to bed 44, and transported for use on another patient lying another bed. In this way, a single device can be used between a plurality of beds in order to turn a plurality of patients. Typically, a plurality of sheets suitable for connection to the rollers of the device are provided. Each bed that the device is intended to be used upon is provided with a separate sheet of this type.

FIGS. 4 and 5 show a mechanism by which rollers 51, 53 are driven by motors 55, 57. The rollers are mounted on a twin boom and twin mast arrangement similar to the arrangement presented in FIGS. 1 to 3. A mast 67 and a boom 59 are visible in the end view shown in FIG. 4. FIG. 5 shows the drive chain linking the motor 55 with the roller 51. The motor 55 rotates a first drive shaft 50 which is linked to a second drive shaft 52 via an endless belt 54. The second drive shaft 52 has a cam 56 which, when the roller 51 is in its operative position, is in driving contact with a cam follower element 51a of the roller 51. The cam follower 51a may engage the cam 56 in any acceptable manner, such as via their front surfaces, via the cam follower being located in a recess of the cam, or by the cam being located in a recess of the cam follower. The ends of the rollers 51, 53 are securely held in cradles 63 which downwardly depend from a boom. The rollers 51, 53 freely rotate in the cradles 63.

In the embodiment shown in FIGS. 1 to 3, the motors 36, 38 are both controlled by a single control arrangement (not shown) which is configured so as to drive the motors 36, 38 in unison so as to perform a desired task. For example, when it is desired to lift the patient up, the control arrangement drives roller 32 anticlockwise (with respect to the configuration shown in FIG. 1) and roller 34 clockwise. Similarly, when it is desired to roll the patient, the motors 36, 38 are driven in a common direction. In this way, it is possible to provide a control arrangement having very simple controls which may be used by an unskilled operative. In a preferred embodiment, the control arrangement comprises a keypad, a plurality of dials, or a similar, relatively simple arrangement. The keypad or like arrangement may be located at any given location, such as on the masts or as part of handheld control arrangement. The motors may be of any suitable type—typically electric motors are used. Preferably, in view of the type of motion desired, a rotary motor is employed. However, in principle, a linear motor might be employed together with a linear to rotary converter. It is possible to independently control the motors, although this arrangement is less preferred for reasons of operational simplicity.

The attachment of the sheet to the rollers can be made in a number of ways. In one embodiment, a short length of material is wrapped around and fixed to each of the rollers, and the sheet is attached to this material. Attachment may be through means such as hooks, clips, clamps, slots, or material attachment means such as Velcro®. If material attachment means such as Velcro® are provided on the sheet, it is preferred that such means are provided on both sides of the sheet so that the operation of the device is not dependent on the sheet being disposed on the bed with a particular side of the sheet being face up.

In use the rollers are securely mounted on the device in order to prevent damage being caused by detached rollers. FIG. 6 shows an embodiment of a roller 60 having a main portion 60a, a head portion 60b, a flange portion 60c and a pin 60d mounted on the foot end of the shaft opposite the head portion. Also shown in FIG. 6b is a portion 62 of the drive train in operative connection to a motor (not shown). The drive train 62 includes a cam 64 having projections 64a which mate with recesses 60e formed in the flange portion 60c. FIG. 6c also shows a cradle 66 which is used to support the foot end of the roller 60 opposite the head portion 60b. The cradle 66 includes collars 66a and 66b. The collar 66a has an aperture sized to accommodate the main portion 60a of the roller, whereas the collar 66b has a recess sized to accommodate the pin 60d of the roller. The roller 60 is mounted in place by locating the pin 60d in the cradle 66b, which can only be achieved when the roller is positioned in the cradle 66a. Thus, correct alignment of the roller 60 is ensured. The roller 60 is engaged with the cam 64 by locating the projection 64a of the cam 64 in the recesses 60e of the roller 60. Either the drive train 62 or the cradle 66 may be moveable so as to ensure that the roller 60 is held in place during use, the drive train 62 or cradle 66 being partially removed after use in order to enable the roller 60 to be detached from the device. It is possible to ensure that movement of the drive train 62 or cradle 66 is only possible when the motors are not running. The control arrangement may be configured to ensure that this is the case.

FIGS. 7 to 10 depict a second embodiment of a device of the invention, shown generally at 100. The device 100 includes a mobile support, shown generally at 102, which comprises a pair of masts 104, 106, each mast having a substantially horizontal boom 108, 110 extending therefrom, the booms extending in a common direction. In contrast to the booms of the first embodiment, the booms 108, 110 of the second embodiment extend a relatively short distance from the masts 104, 106 so that they only extend across a portion of the width of the bed that it is intended the device is used in conjunction with. In this way, as explained more fully below, improved access to a patient lying in the bed is provided. The support 102 further comprises a pair of horizontally extending legs 112, 114 having a plurality of ground engaging wheels 116 mounted thereon. The masts 104, 106 are cranked in the region in which they are joined to the legs 112, 114, thereby allowing wheels 116 to be positioned directly beneath the masts 104, 106, resulting in a reduction in the overall size of the device 100. The wheels positioned directly beneath the masts 104, 106 have brakes fitted thereto.

The device 100 further comprises a pair of rollers 118, 120 which are substantially parallel and are longitudinally spaced apart. Each roller 118, 120 has a motor that drives its respective roller and which is situated inside each roller. This is an advantageous arrangement both from the point of view of safety, and also because noise levels are reduced, which is an important consideration in, e.g., an ITU. Preferably, the rollers are manufactured from a fibreglass, although other materials would suggest themselves to the skilled person. Advantageously, the poles are permanently attached to the device, which is preferable from a safety point of view. As shown in FIG. 9, a sheet 112 is attached to the rollers, 118, 120. The rollers 118, 120 may be operated in the manner described with regard to the first embodiment of the invention.

The rollers 118, 120 are connected to the booms 108, 110 by arms 124 which are pivotally mounted on boom end plates 126, 128 which themselves are mounted at the distal end of the booms 108, 110. Conveniently, the roller 120 which is disposed beyond the distal end of the booms 108, 110 can be raised and lowered. When the roller 120 is in the raised position, the device can be operated to turn, lift or lower the patient. The roller 120 can be lowered, as shown in FIG. 9, in order to permit access to a patient over the roller 120. In this way, the sheet 122 can remain attached to the device 100 during the entire nursing procedure. FIG. 10 shows a way in which the raising and lowering of a roller can be accomplished. As shown in FIG. 10, a boom end plate 130 has a slot 132 in which a pin 134 is disposed. An arm 124 is pivotally mounted on the pin 134. The slot 132 has first and second notches 136, 138 disposed at opposing ends of the slot 132. When the pin 134 is disposed in the first notch 136, contact with a floor 140 of the boom end plate 130 prevents downward movement of the arm 124 and thus ensures that the arm 124 is in the raised position. The arm 124 is lowered by moving the pin from the first notch 136 to the second notch 138. When the pin 134 is in the second notch 138, the arm 124 can move downwards by pivoting about the pin 134 to a lowered position where the arm 124 rests against an edge of the floor 140. Advantageously, the length of the slot 132 is designed so as to compensate for the horizontal movement of the arm 124 that occurs during rotation, so that the arm 124 is at a constant or near constant horizontal separation from the boom end plate 130 in both the raised and lowered position. Preferably, a similar arrangement is provided for the other roller, so that both rollers can be raised and lowered. The arrangement shown in FIG. 10 enables the rollers to be raised and lowered manually. Other arrangements, including powered arrangements, would readily suggest themselves to the skilled person. Advantageously, sensors detect when the arms are engaged fully in the raised position, and a control system ensures that the rollers can only be rotated once the sensors have determined that the arms are fully engaged in the raised position.

FIG. 8 shows how the longitudinal position of the rollers 118, 120 can be adjusted with respect to a bed that the device 100 is positioned against. Each arm 124 is pivotally connected to a roller 118, 120 and to a boom end plate 126, 128 in a suitable manner, for example via horizontal hinges or by directly receiving a pivot pin. Two of the arms 124 which are in connected with a common boom end plate 128 are each connected additionally to a secondary arm 142. The secondary arms 142 are in connection with and are driven by a linear actuator 144. The skilled reader will appreciate that linear movement of the actuator 144 causes movement of the arms 124 which in turn produces longitudinal translation of the rollers 118, 120. This movement also causes a certain amount of horizontal movement of the rollers; however, over the range of longitudinal motion typically utilised in devices of the invention (generally around 10 to 20 cms) this horizontal movement is unimportant. It is advantageous that the system depicted in FIG. 8 causes both rollers 118, 120 to move in unison. It is also advantageous that the rollers 118, 120 can both be moved by the application of a single force at a single point of application. The actuator 144 can be attached to a boom. Typically, the actuator 144 is mounted close to the boom 110 which is intended to be disposed at the foot of a bed. Generally, the motors for driving the rollers 118, 120 will also be disposed at this end of the device, although other arrangements are possible.

The skilled reader will appreciate that many other arrangements for causing longitudinal motion of the rollers 118, 120 are possible. For example, the booms or boom end plates may be provided with tracks in which the rollers or a connecting structure such as arms can slide. A single track may be provided which runs longitudinally with respect to the bed. Arrangements in which the longitudinal motion of the rollers is powered is preferred, although a manual mechanism might be employed. This facility provides the advantage that the position of the rollers with respect to the bed can be changed without requiring manual intervention from an operative or the use of slide sheets, which can also cause injury to the operative. Longitudinal movement of the rollers might be necessitated if the wheels or base of the bed are in an adverse position that prevents the base of the device being positioned with respect to the bed in a desired position or when the approach is hindered. Dedicated patient hoists utilising these principles can be provided so as to enable longitudinal adjustment of the patient's position.

FIG. 11 depicts a third embodiment of a device of the invention, shown generally at 140. The device 140 includes a mobile support, shown generally at 142, which comprises a pair of masts 144, 146, each mast having a substantially horizontal booms 148, 150 extending therefrom, the booms extending in a common direction. In common with the second embodiment, the boom 148, 150 extend a relatively short distance from the masts 144, 146 so that they only extend across a portion of the width of the bed that it is intended the device is used in conjunction with. The support 142 further comprises a pair of horizontally extending legs 152, 154 having a plurality of ground engaging wheels 156 mounted thereon. The device 140 further comprises a pair of rollers 158, 160 which are substantially parallel and are longitudinally spaced apart. Each roller 158, 160 has a motor which drives its roller in a manner described above. A sheet 162 is attached to the rollers 158, 160. The rollers 158, 160 are connected to the booms 148, 150 by arms 164 mounted on the booms 148, 150. Each arm 164 is articulated or otherwise segmented a short distance from its respective boom 140, 150 so as to enable the rollers 158, 160 to be raised and lowered in order to permit access to a patient over a roller.

The principle of providing longitudinal adjustment can be utilised in a dedicated hoist device for lifting and lowering a patient. Such a device may include a pair of rollers which are turned in unison so as to lift and lower a patient. However, other devices that utilise different ways of lifting and lowering of patients might advantageously incorporate longitudinal adjustment means. FIG. 12 shows a dedicated lifting and lowering device, depicted generally at 170. The device includes a mobile support 172 which has many of the features of the mobile support of the third embodiment shown in FIG. 11: identical numerals are used to denote such shared features. The mobile support 172 has a pair of booms 174, 176 which are each shaped in a dog-leg arrangement. A pair of tracks 178, 180 extend between the end regions of the booms 174, 176 so that, in use, the tracks 178, 180 extend substantially longitudinally with respect to the bed on which the patient to be lifted resides. A hoist 182 is provided which can support a sling that depends therefrom and is operable so as to raise and lower the sling. The hoist 182 is connected to a carriage 184 that is mounted on the tracks 178, 180. The carriage may be moved along the tracks 178, 180 by any suitable means, such as manual operation, or powered operation provided by a suitable device such as a motor or an actuator. In this way longitudinal adjustment of the position of the patient with respect to the support 172 is provided.

Various modifications would readily suggest themselves to the skilled person. For example, the height of the booms with respect to the masts may be adjustable, as might the length of the booms and/or the position of the rollers along the booms. A two-piece arrangement, in which each roller is held on a separate device which is assembled in an appropriate way around a bed, is within the scope of the invention. However, such arrangements are less preferred, since transportation of such an arrangement is more involved and the arrangement must be assembled with the correct mutual alignment. The rollers may be provided in different lengths to accommodate different length beds and different types of patients such as pediatrics, spinal injury and orthopedic patients, where a leg or total body roll is performed. In order to accommodate different roller lengths the overhanging portion needs to be adjustable. One way of doing this is to utilise a horizontal strut 20 or similar spacer arrangement having an adjustable length. In further embodiments the rollers are not powered by motors but rather are turned manually, for example by using a clutch and handle to turn each roller. Such embodiments might be used in field hospitals, and other applications such as emergency situations where electrical power is not available. In other embodiments, the booms may have one or more downwardly depending members on which the rollers and/or the motor are mounted. In other embodiments still the drive arrangement, the motor and its respective roller may be substantially co-linear, in contrast to the arrangement shown in FIG. 5.

The present invention provides economic advantages, since a single device may be used in conjunction with a variety of beds. Additional advantages are that the device may be used by an unskilled operative, enabling a single such operative to turn a plurality of patients. The provision of two rollers enable patients to be rolled either clockwise or anticlockwise and thus enables a patient to be rolled back to their original position at the end of the procedure. In addition to having utility in medical institutions such as hospitals, the devices of the present invention might usefully be employed in other areas, such as use in the general community by personnel such as district nurses.

1. Apparatus for turning a patient including a mobile support having an overhanging portion defining a pair of spaced locations, a roller mounted at each location such that the rollers extend generally parallel to each other, the rollers together being for supporting a dependent sling therebetween, and means for rotating the rollers whereby the sling can be moved laterally relative to the patient to turn the patient.

2. Apparatus according to claim 1 in which the means for rotating the rollers can additionally rotate the rollers to shorten the sling so as to lift a patient lying therebetween.

3. Apparatus according to claim 1 in which the mobile support comprises a single structure.

4. Apparatus according to claim 1 in which the mobile support comprises two or more linked structures.

5. Apparatus according to claim 1 in which the rollers have releasable coupling means for releasably coupling the rollers to the sling.

6. (canceled)

7. Apparatus according to claim 1 in which the mobile support includes one or more uprights, preferably at least two uprights, most preferably two uprights.

8. Apparatus according to claim 1 in which the overhanging portion includes at least two cross members.

9. Apparatus according to claim 8 in which the overhanging portion further includes a linking arrangement linking the rollers to the cross members.

10. Apparatus according to claim 9 in which the cross members extend substantially transversely with respect to the rollers up to a transverse limit, and at least a portion of the linking arrangement extends substantially transversely with respect to the rollers beyond the transverse limit of the cross members.

11. Apparatus according to claim 1 further including means for lowering and raising a roller between a raised, in-use position and a lowered position.

12. Apparatus according to claim 11 in which the means for lowering and raising a roller includes a lever mechanism.

13. Apparatus according to claim 11 in which the means for lowering and raising a roller includes a linking arrangement linking the rollers to the cross members, the linking arrangement being included in the overhanging portion.

14. Apparatus according to claim 1 further including adjustment means for adjusting the longitudinal position of the rollers with respect to the overhanging portion.

15. Apparatus according to claim 14 in which the adjustment means includes a pivotably mounted connector connected to the rollers.

16. Apparatus according to claim 14 in which the adjustment means includes a linking arrangement liking the rollers to the cross members, the linking arrangement being included in the overhanging portion.

17. Apparatus according to claim 14 in which the adjustment means includes sliding means enabling the rollers to slide longitudinally with respect to the overhanging portion.

18. Apparatus according to claim 17 in which the sliding means includes one or more tracks disposed on the overhanging portion on which a roller can slide.

19. Apparatus according to claim 14 in which the adjustment means further includes drive means for causing longitudinal movement of the rollers.

20. Apparatus according to claim 19 in which the drive means includes an actuator.

21-27. (canceled)

28. Apparatus for turning a patient including a support defining a pair of spaced locations, a roller mounted at each location such that the rollers extend generally parallel to each other, the rollers together being for supporting a dependent sling therebetween, means for rotating the rollers whereby the sling can be moved laterally relative to the patient to turn the patient, and adjustment means for adjusting the longitudinal position of the rollers with respect to the support.

29. Apparatus for lifting and lowering a patient including a support carrying sling supporting means for supporting a dependent sling and operable to lift and lower a patient lying in the sling, and adjustment means for adjusting the longitudinal position of the sling supporting means with respect to the support.

30. Apparatus for lifting and lowering a patient according to claim 29 in which the support includes an overhanging portion carrying the sling supporting means.

31. Apparatus according to claim 30 in which the overhanging portion defines a pair of spaced locations, the sling supporting means includes a roller mounted at each location so that the rollers extend generally parallel to each other, the rollers together being for supporting the dependent sling therebetween, and means for rotating the rollers whereby the sling can be shortened so as to lift a patient lying therebetween and lengthened so as to lower a patient lying therebetween, and the adjustment means adjusts the longitudinal position of the rollers with respect to the overhanging portion.

32. Apparatus for lifting and lowering a patient according to claim 29 in which the support is a mobile support.
